(19) United States
(12) Patent Application Publication
(10) Pub. No.: US 2003/0126909 A1
(43) Pub. Date: Jul. 10, 2003

(54) System and method for monitoring the slurry specific gravity by using the electrophoretic technology

(75) Inventors: Yung-Tai Hung, Chia-I (TW); Chi-Tung Huang, Hsin-Chu (TW)

Correspondence Address: LOWE HAUPTMAN GILMAN & BERNER, LLP, Suite 310, 1700 Diagonal Road, Alexandria, VA, 22314, US

(73) Assignee: Macronix International Co., Ltd.

(21) Appl. No.: 10/036,393

(22) Filed: Jan. 7, 2002

(51) Int. Cl. G01N 9/00

(52) U.S. Cl. 73/32 R

(57) ABSTRACT

The basic mechanism of this invention has three essential steps: firstly, let these abrasives of the slurry be charged; secondly, apply a current on these electrodes so let at least partial abrasives be accumulated on these electrodes; thirdly, calculate the specific gravity of slurry in accordance with a relation which is a function of both the accumulated abrasives and the current. The system essentially has some electrodes and a power source, which is used to apply a current through these electrodes into a slurry inside the pipeline. Herein, the power source usually is a constant current source or a constant voltage source. Besides, this system could further have a device for measuring the weight the accumulated abrasives.

### BACKGROUND OF THE INVENTION

1. Field of the Invention

This invention relates generally to monitor the slurry specific gravity of a slurry, more particularly, the invnetion relates to monitor the slurry specific gravity of a slurry by using the electrophoretic technology but not by using the sonic variation.

2. Description of the Prior Art

The slurry, such as the chemical mechanical polishing (CMP) slurry, is broadly applied in the contemporary semiconductor fabrication. Moreover, the characteristics of the slurry usually are strongly dependent on the specific gravity of the slurry, or called as the number density of abrasives inside the slurry.

Conventional technologies usually use the sonic variation to measure the specific gravity of the slurry. As FIG. 1 shows, the conventional systems for monitoring the slurry specific gravity of a slurry usually have variation source 11, slurry tank 12, slurry 13, and detector 14. Slurry 13 is located inside slurry tank 12, variation source 11 is used to produce a wave in slurry 13, and detector 14 is used to measure the wave that propagates through slurry 13, such as to measure the amplitude and the frequency. Because the propagation of the produced wave is strongly affected by the properties, such as density and viscosity, of slurry 13, by comparing the motion of variation source 11 and the wave measured by detector 14, the specific gravity of slurry 13 could be easily found.

Obviously, because the essential mechanism of the conventional technologies is to find the specific gravity of slurry 13 by analysising the wave in slurry 13, any wave that is not produced by variation source 11 would induce irnegligible noise(s) and increase the difficulty to precisely analysis. For example, the turbulent flow would induce an additional wave which is independent on the motion of variation source 11, and then a direct result is that the wave measured by detector 14 not only is related to known motion of variation source 11 but also is related to unknown effect of the turbulent flow. Thus, the calculated specific gravity would have a significantly error which induced by the turbulent flow.

Accordingly, the conventional technologies only could effectively measure the static slurry, i.e., only could measure the slurry in the reservoir but could not measure the slurry in the pipeline which conducts the slurry from the reservior into a chamber. In other words, conventional technologies could not in-time monitor the slurry inside the pipeline, especially inside the terminal closed to the chamber. And then, any variation of slurry specific gravity, which happened during the propagation of the slurry, could not be effectively monitored.

### SUMMARY OF THE INVENTION

One main object of the invention is to provide a method for effectively in time measuring the slurry specific gravity.

Another object of the invention is to provide a method for measuring the specific gravity of the slurry, which is located close to the chamber.

Still an object of the invention is to provide a technology for measure the slurry specific gravity with the advantages of finite easy steps and simple required machine(s).

In order to achieve the previous objects, the claimed invention discloses a method has three essential steps: firstly, let these abrasives of the slurry be charged; secondly, apply a current on these electrodes so let at least partial abrasives be accumulated on these electrodes; finally, calculate the specific gravity of slurry in accordance with a relation which is a function of both the accumulated abrasives and the current. The system to achieve the previous method at least has some electrodes and a power source, which is used to apply a current through these electrodes into a slurry inside the pipeline. Herein, the power source usually is a constant current source or a constant voltage source. Besides, this system could further have a device for measuring the weight the accumulated abrasives.

By using the invention, because each component of the slurry is known when the slurry is produced or is used, the specific gravity of the slurry essentially is related to the ratio between different components of the slurry. And because the slurry usually is the mixture of numerous abrasives and a solvent, which could be the mixture of several solvents. The essential idea of the present invention is that the specific gravity of the slurry is directly proportional to the number density of the abrasives. For a unit volume slurry, the more existent abrasives, the higher specific gravity.

Hence, the essential mechanism of the present invention is to measure the number, or number density, of the abrasives, and then to acquire the specific gravity by simply calculating in accordance with the number ratio between the abrasives and the solvent(s) and the material(s) of both the abrasives and the solvent(s).

Further, the essential mechanism of the present invention also is to measure the number, or number density, of the abrasives by using the electrophoretic technology. Note that the number of the accumulated abrasives is directly proportional to the total applied chargers appears on the electrodes, and the variation of the current appears on the electrodes also is directly proportional to the number of accumulated abrasives. Reasonably, by properly measure the number of all applied chargers and/or the variation of the current, the number of the accumulated abrasives could be easily found.

### BRIEF DESCRIPTION OF THE DRAWINGS

A more complete appreciation and many of the attendant advantages will be readily obtained as the same becomes better understood by reference to the following detailed description when considered in connection with the accompanying drawings.

FIG. 1 shows the essential configuration of one popular conventional system for measuring the slurry specific gravity;

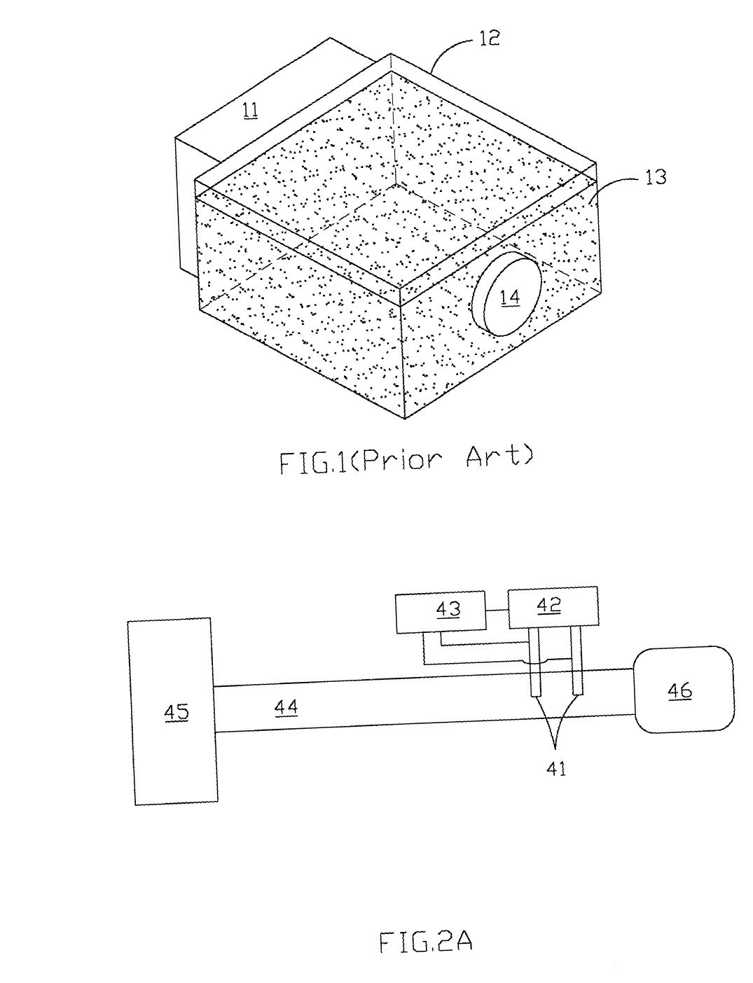

FIG. 2A through FIG. 2D show four possible configuration of the present system of the claimed invention.

FIG. 3 shows the essential steps of the present method of the claimed invention; and

FIG. 4A and FIG. 4B separately shows the ampere-time relation and the voltage-time relation, both relations are the basis to calculate the specific gravity of the slurry.

### DESCRIPTION OF THE PREFERRED EMBODIMENT

Some examples and concepts are discussed in detail below, and are used to clearly explain this invention. However, it should be emphasized that this claimed invention could be applied to other applications and is not limited by these. Therefore, available scopes of only should be limited by the claims.

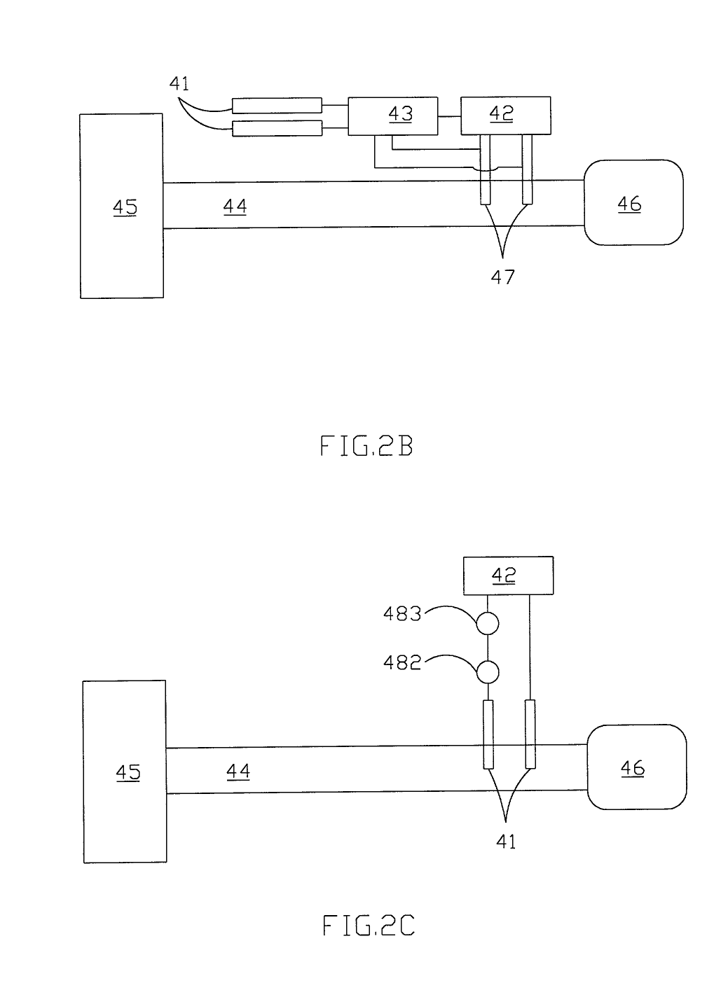

Initially, a system for monitoring the slurry specific gravity by using the electrophoretic technology is introduced. As FIG. 2A shows, the present system at least has numerous electrodes 21, power source 22, and calculating assemble 23.

Each of numerous electrode 21 at lest is partial located in pipeline 24, where pipeline 24 is used to conduct a slurry which has numerous abrasives, from slurry source 25 into chamber 26. Power source 22 is used to apply a current on electrodes 23 so let at least partial these abrasives be accumulated on electrodes 21. Moreover, calculating assemble 23, which usually has one application specific integrated circuit or an micro-calculator, is used to calculate the specific gravity of the slurry in accordance with a function of both the accumulated abrasives and the current.

Herein, as discussed above, power source 22 could be a constant current source, a constant voltage source, or any available power source. Besides, the kind of power source 22 is strongly dependent on what method is used by calculating assemble 23.

Moreover, because the electrophoretic technology does not require the slurry is static, in order to exactly handle the specific gravity of the slurry that is conducted into chamber, it is possible to let at least one of electrodes 21 be located closed to the terminal of pipeline 24 which is contacted with chamber 26. Herein, FIG. 2A shows the case that all electrodes 21 are closed to chamber 26, but it should be noted that the invention does not require electrodes 21 are distributed in this way.

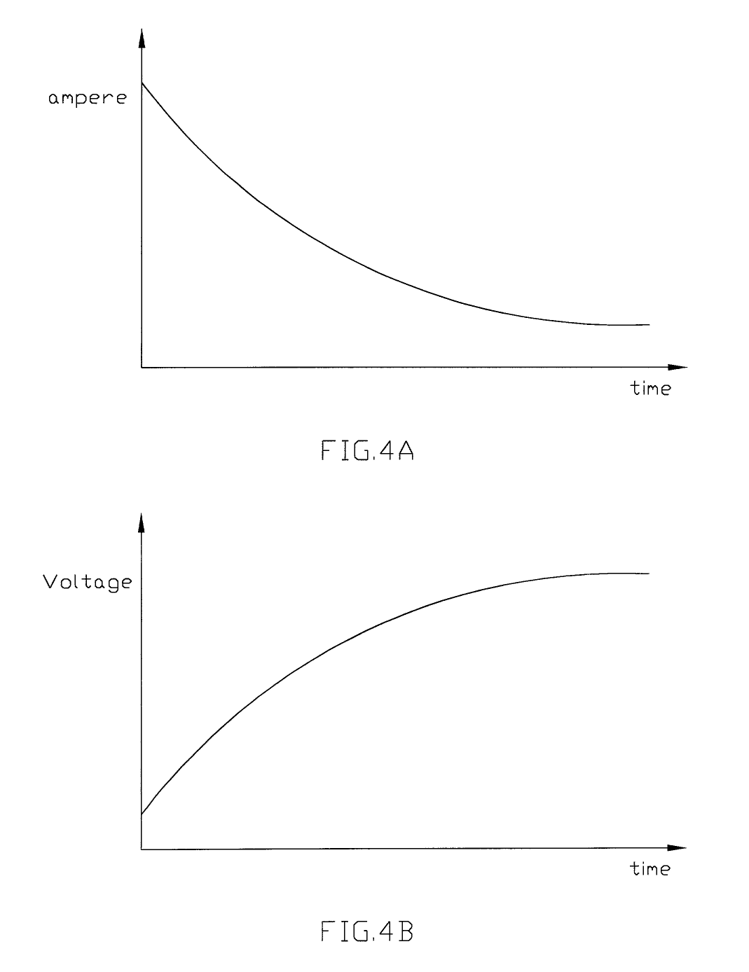

Further, while calculating assemble 23 calculating the specific gravity of the slurry by calculating the weight of the accumulated abrasives, as FIG. 4B shows, the system could further comprise some additional electrodes 27. Herein, additional electrodes 27 are putted into the slurry and to continuously measure the slurry while the electrodes 21 are removed to measure the weight of the accumulated abrasives on the electrodes 21. Note that electrodes 21 usually are separated from power source 22 while electrodes 21 are moved away pipeline 24.

Moreover, as FIG. 2C shows, while calculating assemble 23 calculating the specific gravity of the slurry by using constant voltage source 281, the system could further comprise time meter 282 and ampere meter 283, both usually are a part of calculating assemble 23. Herein, time meter 282 is used to in-time measure the period that the current is applied, and ampere meter 283 is used to in-time measure the ampere of the current. Certainly, FIG. 2C only is a specific configuration, time meter 282 and ampere meter 283 need not be arranged in sequence, the only limitation is that each current loop has a corresponding ampere meter 283. The location of time meter 282 is changeable, and the number of time meter 282 also is changeable.

Besides, as FIG. 2D shows, while calculating assemble 23 calculating the specific gravity of the slurry by using constant current source 291, the system could further comprise time meter 292 and a voltage meter 293, both usually are a part of calculating assemble 23. Herein, time meter 292 is used to in-time measure the period that the current is applied, and voltage meter 293 is used to in-time measure the voltage of the current. Similarly, FIG. 2D only is a specific configuration, time meter 292 and voltage meter 293 need not be arranged in sequence, the only limitation is that each current loop has a corresponding voltage meter 293. Both the location of time meter 292 and the number of time meter 292 are changeable.

Finally, it should be note that because the electrophoretic technology used by the invention is a well known technology, although the specification does not introduce the details of the electrophoretic, the application of the present invnetion is easy for any one who understand the well known electrophoretic technology.

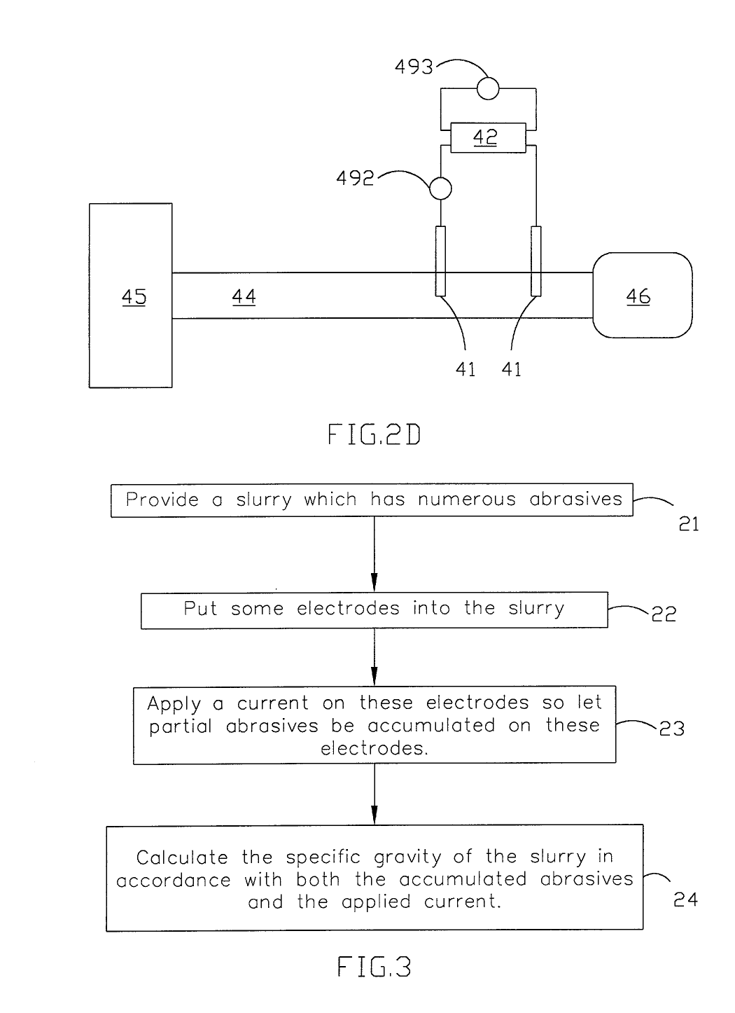

Sequentially, a method for monitoring the slurry specific gravity by using the electrophoretic technology is disclosed, the method corresponds to the previous system. As shown in FIG. 3, the method at least has following essential steps:

As providence block 31 shows, provide a slurry which has numerous abrasives.

Herein, the slurry could be any slurry that has numerous abrasives which could be charged, for example, the slurry could be the slurry of the chemical mechanical process. Moreover, at least in order to let the abrasives could be charged and be dispersed, the slurry usually could have one of the following: numerous interface active agents, numerous disperse agents, and numerous disperse colloids.

As preparation block 32 shows, put some electrodes into the slurry. Herein, the electrodes usually at least have an anode and a cathode.

As current block 33 shows, apply a current on these electrodes so let partial abrasives be accumulated on these electrodes.

Note that the invention only requires the abrasives are attracted by the electrodes and are accumulated on the electrodes, the invention never concerns when and how the abrasives are charged. In other words, the abrasives could be charged before the electrodes are putted into the slurry, the abrasives also could be charged after the electrodes are putted into the slurry, and the abrasives even could be charged by the current from the electrodes. In fact, the only limitation is that the abrasives are charged so let they could be attracted by the electrodes. Thus, any method could be used by the claimed invention to charge the abrasives.

As calculation block 34 shows, calculate the specific gravity of the slurry at least in accordance with the accumulated abrasives and the applied current.

Herein, the calculation also could be dependent on both the information about the weight of the accumulated abrasives and the total quantity of said slurry, be dependent on both the ampere of the current and the action period of the time, be dependent on both the voltage of the current and the action period of the time. In addition, the details of calculation block 34 are further explained in the following paragraphs.

Initially, because the Faraday's law teaches the quantity of electrolyzed materials (or electroplated materials) is directly proportional to the chargers currents through the electrolyte, the specific gravity of the slurry could be calculated by using the Faraday's law. By controlling the charges that flow through the slurry and the total quantity of the slurry, and by the knowledge that each abrasive would carry how many chargers, the total number of accumulated abrasives could be found. Then, the specific gravity of the slurry could be found by a simple calculation.

Furthermore, the number of the accumulated abrasives also could be simply found by directly measuring the weight of the accumulated abrasives. Because the molar weight of the abrasives is known, the method could easily find the number of the accumulated abrasives without precisely controlling the flow and the active period of the current. Sequentially, by comparing the number of the accumulated abrasives and the total quantity of the measured slurry, the specific gravity of the slurry could be easily found.

Certainly, the electrodes must be moved away the slurry to measure the weight of the accumulated abrasives on the electrodes. Thus, to effectively continuously measure the slurry, the method could further comprising the step of putting some additional electrodes into the slurry while the electrodes are removed to continuously measure the weight of the accumulated abrasives.

Significantly, because the accumulated abrasives are attracted by the current appears on the electrodes, the reaction is independent on the motion of the slurry. Thus, this invention could be used to measure the specific gravity of static slurry, and also could be used to measure the specific gravity of flowing slurry. To compare with the conventional technologies discussed above, the invention not only could measure the static slurry in the reservoir as what the conventional technologies do but also could measure the flowing slurry in the pipeline while the conventional technology can not do. In particularly, the invention could be used to measure the specific gravity of the slurry that just being transferred into the chamber.

Besides, owing to the invention measures the specific gravity by continuously inputting the current into the slurry, the invention further presents two methods which continuously dynamically monitor the variation of the specific gravity of the slurry by measuring the electrical signal(s).

Both methods are based on the truth that each accumulated abrasive would lose charger(s) to the attached electrode. In other words, the accumulated abrasives would form the neutral layer(s) on the attached electrode(s) and then form a resistor on the current path. Thus, because the resistance of the resistor (the number of accumulated particles) would be increased during the active period of the current, to continuously monitor the variation of the current could continuously monitor the variation of the number of the accumulated abrasives.

The first method is to provide the current by a constant voltage source to some electrodes (all are anodes or all are cathodes), and to measure the relation between the ampere of the current, which flows through the slurry to other electrodes (all are cathodes or all are anodes), and the period that the current is applied. As FIG. 4A shows, because the thickness of the accumulated abrasives is continuously increased and the voltage of the current is fixed, the ampere of the current, which flows through the slurry to other electrodes, would be continuously decreased. Thus, by analysising the ampere-time relation, it is possible to continuously handle the speed that the abrasives are accumulated, and then it could dynamically monitor the specific gravity of the slurry.

The second method is to provide the current by a constant current source to some electrodes (all are anodes or all are cathodes), and to measure the relation between the voltage of the current, which flows through the slurry to other electrodes (all are cathodes or all are anodes), and the period that the current is applied. As FIG. 4A shows, because the thickness of the accumulated abrasives is continuously increased and the ampere of the current is fixed, the voltage of the current, which flows through the slurry to other electrodes, would be continuously increased. Thus, by analysising the voltage-time relation, it is possible to continuously handle the speed that the abrasives are accumulated, and then it could dynamically monitor the specific gravity of the slurry.

From the foregoing it will be appreciated that, although some examples and concepts of the invention have been described herein for the purpose of illustration, various modifications may be made without deviating from the spirit and scope of the invention. Accordingly, the invention is not limited except as by the appended claims.

What is claimed is:

1. A method for monitoring the slurry specific gravity by using the electrophoretic technology, comprising:
providing a slurry, said slurry comprising a plurality of abrasives;
putting a plurality of electrodes into said slurry;
applying a current on said electrodes so let at least partial said abrasives be accumulated on said electrodes; and
calculating the specific gravity of said slurry in accordance with both accumulated said abrasives and said current.

2. The method of claim 1, owing to the Faraday's law teaches the quantity of electrolyzed materials or electroplated materials is directly proportional to the chargers currents through the electrolyte, the specific gravity of said slurry could be calculated by following steps:
controlling a plurality of charges that flow through said slurry and the total quantity of said slurry;
deciding how many said chargers are carried by each of accumulated said abrasive;
calculating the total number of accumulated said abrasive by using the totally number of said charges, the total quantity of said slurry, and carried chargers of each accumulated said abrasive; and
calculating the specific gravity by using the total number of accumulated said abrasive and the molecular weight of said abrasives.

3. The method of claim 1, the specific gravity of said slurry being calculated in accordance with the weight of said accumulated abrasives and the total quantity of said slurry.

4. The method of claim 1, while said current being provide by a constant voltage source, between the ampere of said current and the period that said current is applied.

5. The method of claim 1, while said current being provided by a constant current source, the specific gravity of said slurry being calculated in accordance with the relation between the voltage of said current and the period that said current is applied

6. The method of claim 1, further comprising the step of putting a plurality of additional electrodes into said slurry while said electrodes are moved away said slurry to measure the weight of said accumulated abrasives, said additional electrodes being used to continuously measure said slurry.

7. A system for monitoring the slurry specific gravity by using the electrophoretic technology, comprising:
a plurality of electrodes, each said electrode at least being partially located into a pipeline that is used to conduct a slurry from a slurry source into a chamber, said slurry having a plurality of abrasives;;
a power source, said power source being used to apply a current on said electrodes so let at least partial said abrasives be accumulated on said electrodes; and
a calculating assemble, said calculating assemble is used to calculate the specific gravity of said slurry in accordance with both said accumulated abrasives and said current.

8. The system of claim 7, at least one of said electrodes being located closed to the terminal of said pipeline which is contacted with said chamber.

9. The system of claim 7, said power source being a constant current source.

10. The system of claim 7, said power source being a constant voltage source.

11. The system of claim 7, further comprising a plurality of additional electrodes which are putted into said slurry while said electrodes are removed to measure the weight of said accumulated abrasives.

12. The system of claim 7, said calculating assemble comprising a time meter and a ampere meter, said time meter being used to in-time measure the period that said current is applied, and said ampere meter being used to in-time measure the ampere of said current.

13. The system of claim 7, said calculating assemble comprising a time meter and an a voltage meter, said time meter being used to in-time measure the period that said current is applied, and said voltage meter being used to in-time measure the voltage of said current.
